(19) United States
(12) Patent Application Publication
(10) Pub. No.: US 2013/0296036 A1
(43) Pub. Date: Nov. 7, 2013

(54) SYSTEMS AND METHODS FOR A POKER TOURNAMENT WITH DYNAMIC PLAYER ENTRY

(71) Applicant: James R. Scott, Las Vegas, NV (US)

(72) Inventor: James R. Scott, Las Vegas, NV (US)

(21) Appl. No.: 13/464,794

(22) Filed: May 4, 2012

(51) Int. Cl. A63F 13/12

(52) U.S. Cl. 463/26

(57) ABSTRACT

A tournament system providing a poker game tournament having dynamic player entry and exit allows new players outside the tournament to enter after registration has closed, while allowing players already in the tournament to exit with a reward for having achieved their current position in the tournament. Players in the tournament may offer their positions in the tournament to outside players via the tournament system. The tournament system may also monitor player standings and provide tournament information to aid outside players in deciding whether or not to pay for an offered position in the tournament.

### BACKGROUND OF THE INVENTION

1. Field of the Invention

The invention relates to tournament games where wagering games are played, and in particular to a system and method for providing a poker tournament with dynamic player entry.

2. Related Art

In traditional tournament games of various types, a number of entrants are gradually eliminated leaving the last entrants or entrant as the winner. Typically, during a tournament, entrants engage in contests where at least one entrant that fails to meet particular criteria is eliminated. For example, in a traditional poker tournament, entrants may play poker games, with those that lose all their chips or other currency being eliminated as the tournament progresses.

This process may continue until the number of entrants is whittled down to one, who is deemed the winner of the tournament. Depending on the particular tournament being conducted, a number of prizes may be awarded to the entrants remaining towards the end or at the end of the tournament. For example, in some tournaments, a set number of players remaining at the end of the tournament may be awarded prizes of varying values. In other tournaments, only the overall winner may be awarded a prize.

From the discussion that follows, it will become apparent that the present invention addresses the deficiencies associated with the prior art while providing numerous additional advantages and benefits not contemplated or possible with prior art constructions.

### SUMMARY OF THE INVENTION

A poker tournament having dynamic player entry and exit is disclosed herein. The poker tournament provides the benefit of allowing players to both enter and exit the tournament even after registration has closed. In addition, players exiting the tournament may offer their positions for a price and therefore obtain some benefit for the position in the tournament that they have achieved. Likewise, players outside the tournament may enter at times they deem opportune by accepting an offer. Outside players may also enter the tournament for other reasons such as to play against particular tournament players, to experience particular rounds of a tournament, or the like.

The poker tournament may include a tournament management system for conducting a poker tournament. In one exemplary embodiment, the tournament management system may comprise one or more servers configured to record an amount of tournament currency belonging to a plurality of players registered in the poker tournament, and one or more offer devices configured to receive an offer price from a first player and to transmit the offer price to the servers where the first player is one of the plurality of players registered in the poker tournament.

One or more acceptance devices may be configured to receive an offer identifying the offer price and the amount of tournament currency belonging to the first player and to transmit an acceptance message to the servers when engaged by a second player, where the second player is not registered in the poker tournament. The acceptance devices may be further configured to receive payment for the offer price.

The servers may be configured to assign the first player's tournament currency to the second player after the acceptance message is received from the second player. In this manner, the second player may take over the first player's position in the poker tournament. In addition, the servers may be further configured to transfer at least a portion of payment of the offer price from an account of the second player to an account the first player.

In online embodiments, the offer devices may be further configured to present a poker game for play by the plurality of players registered in the poker tournament. Likewise, the acceptance devices may be further configured to present a poker game for play by the plurality of players registered in the poker tournament.

It is noted that the servers may be further configured to receive the offer price only after a breaking event has occurred. In addition, the servers may be further configured to assign the second player to one of a plurality of subgroupings of the plurality of players registered in the poker tournament. The servers may be further configured to remove the first player from the plurality of players registered in the poker tournament.

In another exemplary embodiment, a poker tournament management server may be provided. The poker tournament management server may comprise one or more storage devices configured to record an amount of tournament currency belonging to a plurality of players registered to play in a poker tournament, and one or more communication devices.

The communication devices may be configured to receive an offer comprising an offer price from a first player (where the first player is one of the plurality of players registered to play in the poker tournament), and receive an acceptance message comprising an identifier identifying the offer from a second player (where the second player is not one of the plurality of players registered to play in the poker tournament). In addition, the communication devices may be configured to transmit tournament information comprising player standings of the plurality of players registered to play in a poker tournament.

One or more processors of the server may be configured to assign tournament currency belonging to the first player to the second player, and to remove the first player from the plurality of players registered to play in the poker tournament upon receipt of the acceptance message. This effectuates the swap of the first player for the second player. The tournament may then continue with the second player. It is noted that this player swap may only occur if the acceptance message is received within a predefined period of time after the offer is received.

The processors may be further configured to distribute the offer to a plurality of players that are not registered to play in the poker tournament via the communication devices. In addition, the processors may be further configured to distribute the offer to the plurality of players that are not registered to play in the poker tournament according to one or more distribution rules. It is noted that the offer may only be distributed after a breaking event has occurred.

Various methods of conducting a poker tournament with a tournament management system are disclosed herein as well. In one exemplary embodiment, such a method might comprise receiving player identifying information from a first plurality of players to register the first plurality of players to play in the poker tournament, storing the identifying information on one or more storage devices, and assigning the first plurality of players to a plurality of subgroups. The players may then play individual poker games within the subgroups. The method may also include recording the amount of tournament currency belonging to each of the first plurality of players on the storage devices.

If at least one of the first plurality of players has no tournament currency (i.e., a breaking event has occurred) the method may proceed by the tournament management system receiving one or more offers including an offer price from one or more of the first plurality of players, distributing the offers to a second plurality of players via one or more communication devices (where the second plurality of players are not being registered to play in the poker tournament), and receiving one or more acceptance messages identifying one of the offers from the second plurality of players.

Various procedures may take place after an offer is accepted. For example, the tournament currency of at least one of the first plurality of players may be assigned to one of the second plurality of players after receipt of the acceptance messages. In addition, least one of the first plurality of players may be from the poker tournament after receipt of the acceptance messages. Also, at least one of the second plurality of players may be assigned to one of the plurality of subgroups after receipt of the acceptance messages. Funds from at least one of the second plurality of players may be electronically transferred to one of the first plurality of players after receipt of the acceptance messages. Lastly, player identifying information may be received from at least one of the second plurality of players and subsequently stored after receipt of the acceptance messages.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a flow diagram illustrating operation of an exemplary tournament with dynamic player entry and exit;

FIG. 2 is a block diagram illustrating an exemplary tournament system;

FIG. 3 is a block diagram illustrating an exemplary client device of a tournament system;

FIG. 4A illustrates an exemplary interface for making position offers in a tournament;

FIG. 4B illustrates an exemplary detail view of tournament information of a tournament;

FIG. 4C illustrates an exemplary interface for accepting position offers in a tournament;

FIG. 5 is a block diagram illustrating an exemplary server of a tournament system;

FIG. 6A is a flow diagram illustrating operation of an exemplary tournament system server; and

FIG. 6B is a flow diagram illustrating operation of an exemplary tournament system server.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the systems and methods disclosed herein provide various poker tournaments where players may dynamically enter or switch (hereinafter “dynamic player entry”) with other players during tournament play. Though the disclosure herein is directed to poker tournaments, it is contemplated that the features of these systems and methods are capable of providing tournaments of various sorts where dynamic player entry or dynamic player switching during tournament play is desired. In addition, online and live tournaments may be provided by the systems and methods herein.

Dynamic player entry provides a number of advantages, which will be detailed further below. Traditional tournaments limit the pool of players to those that signed up or otherwise registered before a predefined registration deadline. Thereafter, new players cannot join the tournament, and players already in the tournament cannot leave without forfeiting their entry fee and any chance they had of winning a prize or other reward.

The poker tournament herein addresses these limitations. As will be described below, the poker tournament provided herein allows players to swap or trade their place in a tournament for a monetary or other reward. Likewise, players who would otherwise not be permitted entry into the tournament would be allowed to enter the tournament even after the registration deadline has passed.

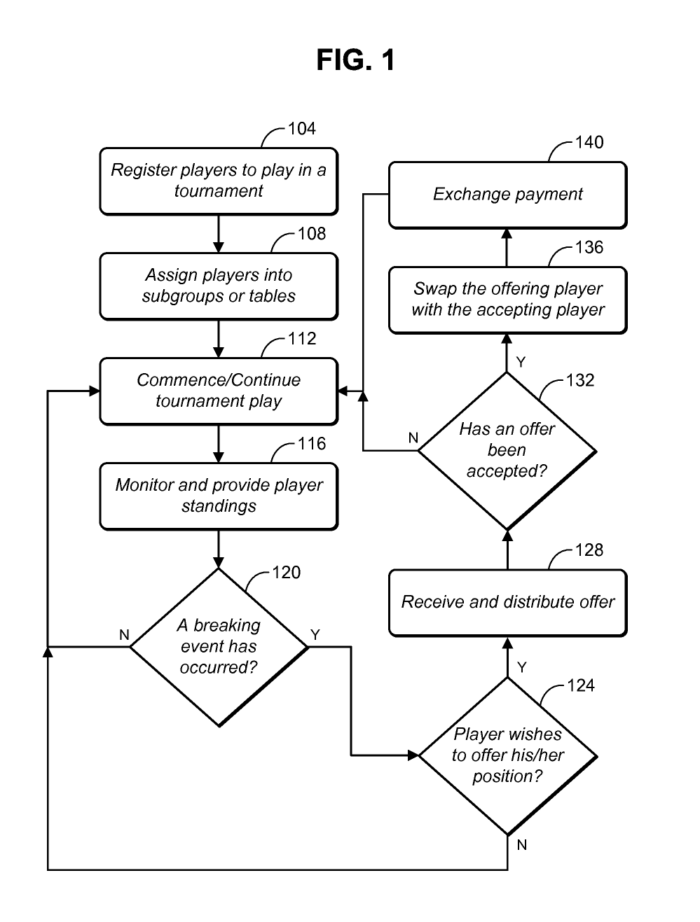

An exemplary poker tournament having dynamic player entry will now be described with regard to the flow diagram of FIG. 1. It is noted that the systems used to provide and conduct a poker tournament in this manner will be disclosed further below. At a step 104, players may be registered for the tournament. In one or more embodiments, players may provide some form of identifying information and pay an entry or registration fee. Identifying information may be the player's name, address, phone number, other contact or address information, or other information capable of identifying the particular player from the other players in the tournament. Since registration may occur electronically, electronic forms of identification may be accepted as well. For instance, players may setup and/or use a username and password, email, or the like to register for the tournament.

Likewise, payment of the entry fee may be accepted electronically, such as via credit card, wire transfer, or via other electronic payment methods. Cash, currency or other physical forms of payment may be accepted as well. For example, payment of a player's entry fee in physical currency may be accepted through a point of sale or similar payment device, such as a bill validator, coin slot, card reader, or the like. It is contemplated that various payment systems, now known and later developed, may be used to collect entry fees for entry into the tournament.

Typically, the entry fee will be a predefined amount for each player that wishes to participate in the tournament. In one or more embodiments, the amount collected as entry fees may be used to define the award pool for the tournament's winner or winners. For example, a tournament having 100 players and a $50.00 entry fee may have $5,000.00 in its award pool. Portions or all of the award poll may be awarded to one winner or multiple winners of the tournament, depending on how the tournament is configured. In one or more embodiments, the gaming establishment or other entity hosting the tournament may collect a portion of the collected entry fees as their fee for providing the tournament.

Registration of players may be closed (i.e., end) at a predefined deadline or based on other criteria. For instance, registration could be closed when a predefined maximum number of players have registered in some embodiments. Typically, once registration is closed, additional players can no longer enter the tournament via the registration procedure described above. However, up until this point, players may be permitted to enter the tournament via registration.

After registration has closed, the players may be organized or grouped into subgroups, such as shown at a step 108. In one or more embodiments, the players may be assigned to tables to accomplish this grouping. It is contemplated that a random number generator or other randomization device may be used to assign players to individual tables. The players will also be given tokens, chips, or other tournament currency that they can wager during play. Typically, all players will begin the tournament with the same number of chips.

Once the players have been assigned to their respective tables, the tournament may begin at a step 112. For instance, each table of players may play one or more rounds of poker starting at step 112. The standings or rankings of the players in the tournament may be generated and presented during the tournament, such as via a leader board. This is shown by step 116 of FIG. 1.

In one or more embodiments, the standings may be based on the amount of tournament currency a player possesses with players having higher amounts tournament currency being ranked higher than those with lesser amounts of tournament currency. Electronic measuring devices, such as token or chip counters may be at each table to track and report the tournament currency each player possesses. The standings or rankings of the players may be continuously updated on the leader board in some embodiments. In other embodiments, the standings or rankings may be updated at predefined intervals or upon occurrence of a triggering event, such as a breaking event, which will now be described with reference to decision step 120 of FIG. 1.

In one or more embodiments, play at individual tables may continue until a breaking event occurs, such as when a scheduled tournament break occurs. The tournament may have one or more of these scheduled breaks. Typically, the breaks will occur at predefined times. For example, there may be a break every 10 or other minutes. During a breaking event, timed tournaments will typically have their timer or clock stopped. It is contemplated that breaking events may also occur for other reasons, such as when one of the players in a subgroup loses all of his or her tournament currency and is eliminated from the tournament.

In one or more embodiments, the tournament manager (or other overseer of the tournament) may initiate a breaking event at all the tables or at one or more particular tables at his or her discretion. To illustrate, the tournament manager may stop play at a particular table if a break is requested or scheduled. Alternatively or in addition, a breaking event may be initiated if the number of players eliminated at one or more tables is sufficient to regroup the players into new subgroups. This regrouping is typically initiated to keep a desired number of players at each table as players and tables are eliminated from the tournament.

As can be seen from FIG. 1, if a breaking event does not occur at decision step 120, play at the subgroup or table may continue at step 112. If a breaking event does occur, the players may be provided an option to offer their position or place in the tournament to an outside player (i.e., a person not currently in the tournament), as shown by decision step 124. If the player does not wish to offer their position, play may continue normally at step 112. If the player does wish to offer their position, such offer may be made at step 128.

Offers may be made in various ways. In general, a player that wishes to offer his or her place in the tournament indicates this desire by setting an offer price for his or her position in the tournament. As will be described further below, the player may make an offer through various electronic systems. This is advantageous in that the offer can be quickly and easily distributed to a large audience of interested outside players. In addition, the responses of outside players can be nearly instantaneously received. This speed allows the tournament to continue with little or no delay. It is noted that outside players may sign up to receive alerts or notifications when a position in the tournament is offered.

At a decision step 132, an outside player may review the offer and either accept or ignore/decline the offer. If the outside player does not decide to accept the offer, play may continue at step 112. If the outside player does accept the offer, the outside player may then take the place of the player that offered his or her position at a step 136. It is noted that in some embodiments the process of swapping an inside player for an outside player, such as described above with regard to steps 124 through 136, must occur during a breaking event.

Typically, the outside player will have to remit payment to the offering player in the amount of the offer price to take the offering player's position. This is shown in a step 140 of FIG. 1. It is noted that a service fee in addition to the offer price may be collected in some embodiments. Alternatively, a portion of the offer price may be collected by the gaming establishment as payment for its services. Payment may occur electronically or via physical forms of payment, as will be described further below.

If not already signed up, the outside player may also need to provide his or her identifying information before taking the offering player's position in the tournament.

The outside player's payment, or a portion thereof, may be transferred to the offering player. The offering player is then taken out of the tournament completing the player swap. Play may then continue at step 112 until the winner or winners are determined.

The option to enter or leave a tournament that is in progress is advantageous to players in the tournament and outside players alike. Both types of players may evaluate the tournament by examining the standings the players therein, and then decide when it may be advantageous for them to enter or leave the tournament. For example, a novice player seeing that only skilled players remain may offer his or her position to an outside player. The novice player may set an offer price such that he or she profits from making it to his or her current position. Alternatively, the novice player may simply try to recoup some or all of his or her entry fee. An outside player may conduct his or her own analysis and decide when it is advantageous for him or her to enter the tournament for the price offered by an offering player.

Outside players may decide they wish to enter the tournament for a variety of reasons. For example, an outside player may wish to play against a particular player or players. Alternatively, an outside player may wish to play only after a particular stage of the tournament. Since there are a variety of reasons for entering during the tournament other than the potential to win an award, players may set different offer prices with a reasonable expectation that an outside player will accept the offer. It is contemplated that the offer price may be accompanied by a short message to make the offer more enticing. For instance, a short message identifying well known or other players an outside player might be playing with after the player swap may be entered. Alternatively, the short message may provide the player's assessment as to the skill level of other players remaining in the tournament. An outside player desiring an easy or difficult tournament may accordingly be more or less willing to pay for a position in the tournament as a result.

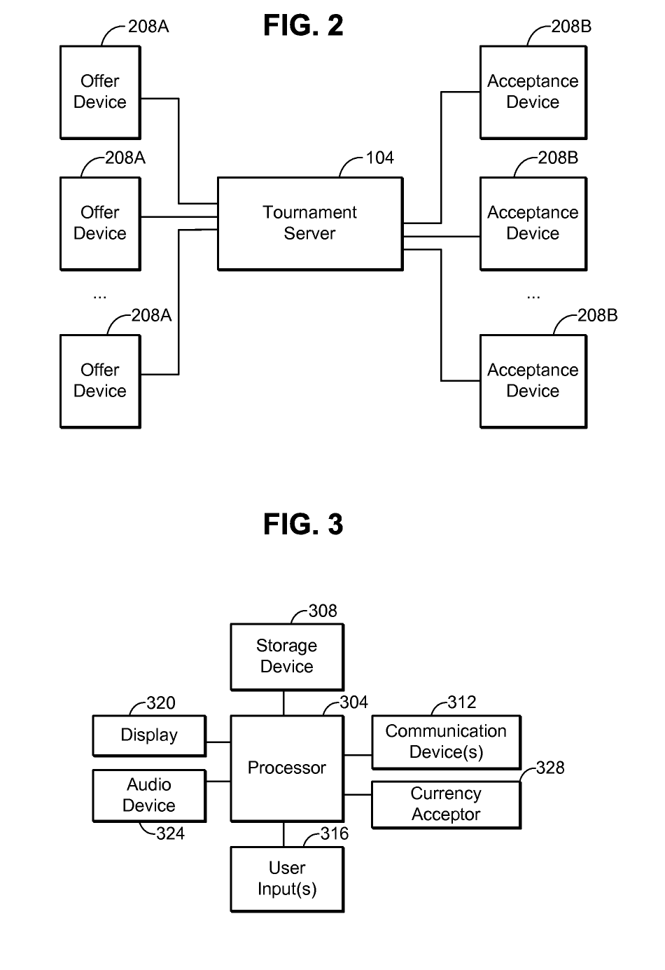

FIG. 2 illustrates and exemplary tournament system configured to provide a tournament as disclosed herein. As can be seen, the tournament system may comprise one or more servers 204 that support the operation of one or more client devices 208. A first and second type of client device 208A,208B, respectively labeled offer and acceptance devices (and collectively referred to as “client devices”), are illustrated in FIG. 2 to show that the client devices may have different modes of operation and/or different configurations. For example, players in the tournament may have an offer device 208A, while outside players utilize an acceptance device 208B, with each type of device being configured for each type of player. To illustrate, an offer device 208A may be configured to allow such players to indicate they wish to offer their position and to collect an offer price for the position, while an acceptance device 208B may be configured to receive offers and allow outside players to accept offers.

It is contemplated that client devices 208 having different physical configurations may be included or used with the tournament system. For example, a client device 208 may be a gaming machine, handheld device, laptop, smart phone, tablet, or other computing device configured to interoperate with the tournament system. In a live tournament, a client device 208 may be in the form of kiosks or the like that players in or outside the tournament may use to offer or accept positions, such as after a breaking event has occurred.

It is noted that in some embodiments, the client devices 208 may switch modes. For example, an outside player's acceptance device 208B may switch modes to become and offer device 208A after the player enters a tournament. This allows the player to offer his or her position once he or she is part of the tournament.

Communication between client devices 208 and a server 204 may occur in various ways. As can be seen, the tournament system may utilize one or more communication links 212 during its operation. These communication links 212 may transmit offers from players in the tournament to players outside the tournament. In addition, the communication links 212 may carry offer responses, indicating whether or not an outside player has accepted an offer. Other information may be communicated between the client devices 208 and server 208 as well. For example, identification information for registration of players, player standings, player statistics, and tournament information (e.g., prize pool, number of players, etc. . . . ) may be shared via the communication links 212.

The communication links 212 may be established via various interfaces in the client devices 208 and server 204. For example, various wired or wireless communication links 212 may be established via corresponding wired or wireless network or other communication interface devices. In addition, the communication links 212 may be capable of supporting various communication protocols, including those that utilize encryption and/or compression for security and efficiency. It is noted that the communication links 212 may extend through various networks, such as LANs, WANs, the Internet, and the like. This permits communication between the client devices 208 and server 204 to occur across distances, large or small, and allows such communication to reach a large audience of players.

It is noted that in an online embodiment, players in and outside the tournament need not be in the same area or facility. This is, at least in part, because the client devices 208 may be configured to allow game play thereon. For example, some or all the players in the tournament may be playing from a client device 208 at their homes, offices, or other remote locations. Similarly, the outside players may also be at various de-centralized locations.

In a live embodiment, players in and outside the tournament may need to be present in the same facility (e.g., gaming establishment). It is contemplated that outside player may be required to at least be in a nearby area or vicinity so that they may take another player's position in the tournament without delaying the tournament. During a live tournament, the players may play at with physical cards and chips (or the like) at tables. Player standings and statistics may be tracked electronically by the tournament system however.

In online and live tournaments offers and acceptances thereof may be made via the tournament system, as described above. For example, a player in the tournament may utilize an offer device 208A to generate and distribute an offer for his or her position to outside players. Likewise, outside players may utilize an acceptance device 208B to receive and accept offers.

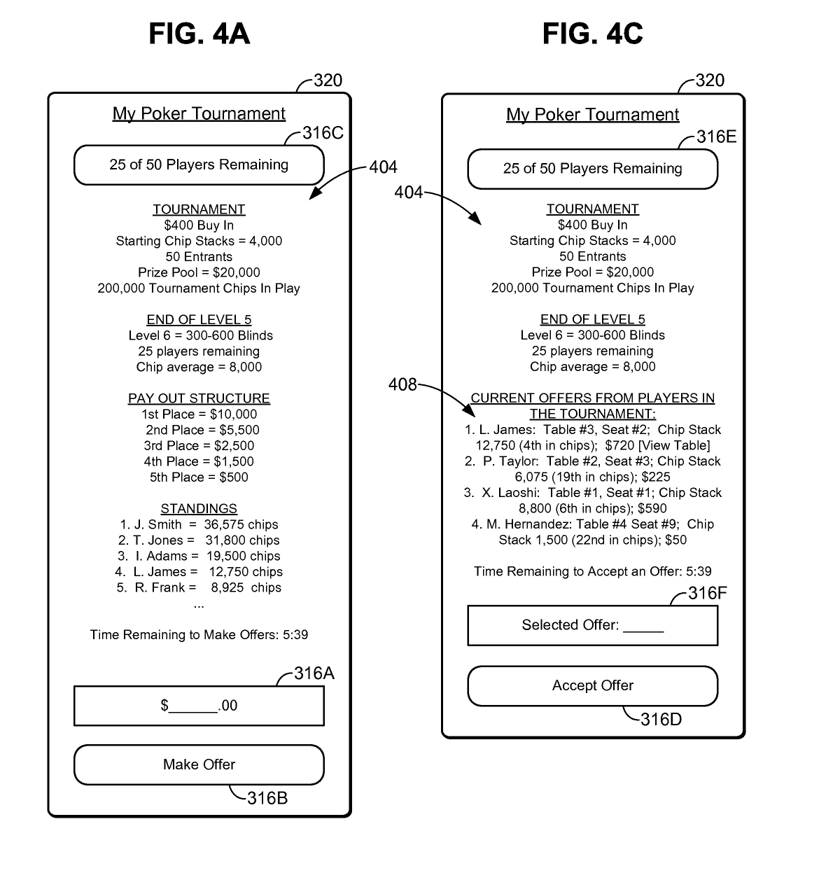

FIG. 3 illustrates an exemplary client device 208 that may be used with the tournament system. As can be seen, a client device 208 may comprise one or more processors 304, storage devices 308, and various input/output devices. In general, a processor 304 may be configured to control operation of the client device 208 so that it may provide the functionality described herein. In some embodiments, the processor 304 may have one or more instructions hardwired therein or be configured to execute instructions in the form of machine readable code to provide such functionality. The processor may utilize a storage device 308 for temporary or permanent storage of data during operation. For example, the machine readable code executable by the processor 304 may be permanently stored on a storage device 308. The storage devices 308 may utilize various data storage technologies. For example, a storage device 308 may be RAM for temporary storage, or be a hard drive, flash drive, optical drive or the like for more permanent storage.

A client device 208 may also include various input/output devices, as stated above. For example, a client device 208 may include one or more display screens 320, audio devices 324, and user inputs 316. In operation, a display screen 320 may provide a user interface to collect offers, receive acceptances, present tournament information (such as player standings and statistics), and various combinations thereof. An audio device 324 may be used to output sounds, such as to alert a player of his or her offer's acceptance or to alert an outside player that an offer has been made. It is contemplated that the audio device 324 may also be used to capture audio, such as to facilitate voice communication between players if desired.

A user input device 316 will generally be configured to collect user input or user commands from players. Some exemplary user input devices 316 include buttons, switches, knobs, touch screens, touch pads, and other control surfaces or devices. A user input device 316 could also be a sensor, such as a proximity sensor, GPS sensor, accelerometer, compass or the like.

A player may provide input to his or her client device 208 via the one or more user input devices 316 included in the client device. Specifically with regard to the tournament system, a player may make and accept offers using the user input devices 316. In addition, a player may play a poker game via the user input devices 316, with the display screen 320 presenting cards or other indicia that the player may view and interact with during play.

In some embodiments, a client device 208 may optionally include a currency acceptor 328 to accept payment for registration fees and/or for making payment for an accepted offer. For example, a client device 208 may include a payment card reader (such as a magnetic swipe or RFID sensor). Alternatively or in addition, a client device 208 may have a bill validator coin/token acceptor.

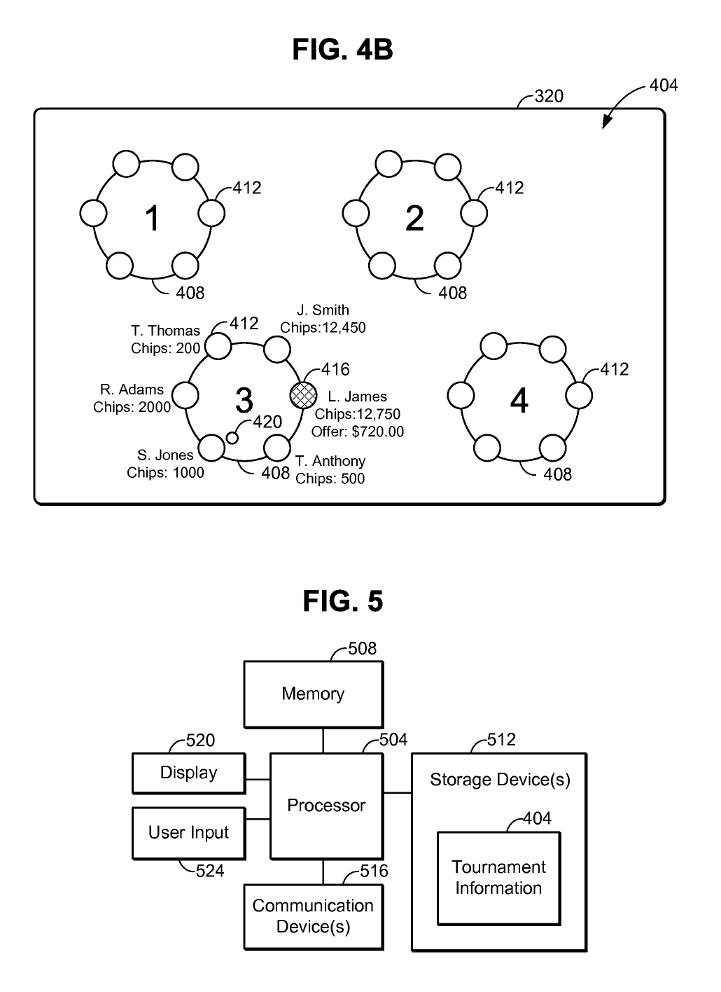

Further details regarding operation of client devices 208 will now be described with regard to FIGS. 4A-4C, which illustrate various exemplary interfaces that may be presented during a tournament. Referring to FIG. 4A, it can be seen that the user interface may be presented via a display screen 320 of a client device. It is noted that the screen 320 may be various sizes and/or be configured to scroll to present different amounts of information. As can also be seen, the user interface may present various tournament information 404 about a tournament. For instance the players' current position or standing in the tournament may be displayed. The number of players remaining in the tournament could also be displayed. Also, the prizes or awards of the tournament may be displayed, such as for reference purposes. A player may refer to the prize or award listing to evaluate his or her chances of winning a prize or award.

The user interface of FIG. 4A is configured to permit a player in the tournament to make an offer for his or her position. As can be seen, the user interface for making offers may include an input field 316A or other input area for accepting a price for the player's position and one or more buttons 316B or the like for making or sending the offer out for distribution to outside players. In some embodiments, a breaking event may be timed so as to end within a predefined period. As shown in FIG. 4A, the time remaining to make an offer may thus be presented as well.

Additional input fields may be provided as well, such as for example to allow a player to enter a promotional or other message about his or her position as discussed above. It is contemplated that various other user inputs may be provided on a client device. For example, in FIG. 4A the portion of the display showing the number of players remaining in the tournament also functions as a button 316C. When pressed additional information or other actions may be initiated by a client device. For example, further details regarding the tournament may be presented regarding the players remaining in the tournament, such as their names (or other identifiers) and amount of tournament currency they possess.

FIG. 4B illustrates an exemplary detail view of tournament information 404 that a player may reach by engaging a user interface button 316A or the like. As can be seen, information regarding the entire tournament may be presented to the player. Though shown in a graphical layout, it is contemplated that tournament information may be presented in list form, via text, or through other arrangements.

In one or more embodiments, such as shown in FIG. 4B, tournament information 404 may be presented to indicate the subgroups 408 (or tables) that the players 412 have been assigned to. Each player's name or other identifying information may also be presented. Each player's amount of tournament currency may also be presented associated with the player's identifier, as can be seen from FIG. 4B. It is noted that the tournament currency could also or alternatively be shown as a ranking number or as a percentage of the total amount of tournament currency in the tournament.

It is contemplated that any players offering their positions may also be displayed in a detail view of the tournament information 404. To illustrate, an offering player 416 has been highlighted (or otherwise differentiated from the other players) to indicate that this player is offering his or her position to outside players. The offer price set by the offering player 416 may also be presented. In addition, the player's identifier and standing could also be displayed.

For a player inside the tournament, the detail view is advantageous in providing a picture of the overall tournament, including which players may or may not be trading their positions to outside players. For outside players, the same picture is provided. In addition, outside players can quickly review the various position offers being made by players in the tournament to make a decision on whether or not to accept one of the offers. In some embodiments, a button 420 indicating play order or position may be displayed along with the other information about the tournament.

FIG. 4C illustrates a user interface for accepting offers. As can be seen, this user interface may also including one or more user inputs, such as buttons 316D,316E. The acceptance button 316D, when engaged, signifies that an outside player wishes to accept and pay for an offer he or she has selected. An offer selection may be received via an input as well, such as the input field 316F shown in FIG. 4C. Other buttons may be used to navigate various presentations of tournament information. For instance, as discussed above, a detail view button 316E may be provided to allow an outside player to retrieve a detail view of tournament information, such as that shown in FIG. 4B.

It is noted that an outside player may select one of the offers in the detail view for acceptance. In some embodiments, the tournament system may allow outside players to establish various criteria specifying what offers they wish to receive. For example, with this capability, an outside player may specify that he or she only receive offers having an offer price within a player defined range, offers for positions within a player defined ranking range, or offers only at player defined stages of a tournament (e.g., only during n number of starting or ending rounds of the tournament). Other criteria are also possible. For instance, an outside player may specify that he or she only wishes to receive offers from particular players in the tournament.

Referring back to FIG. 4C, it can be seen that a user interface for accepting offers may display one or more offers 408 for selection and acceptance. In the exemplary embodiment of FIG. 4C for example, four available offers 408 for the tournament are presented. As can be seen, each offer 408 may include an offer price. In addition, an offer 408 may include details regarding the position being offered, such as how much tournament currency the offering player has (or the player's standing), the players subgroup (or table), other players (and their tournament currency/standings) in the offering player's subgroup. In addition, the offer 408 may include a brief promotional or other message or information about the position if one has been entered by the offering player. An outside player may then select the offer 408 he or she desires and engage the acceptance button 316D or the like to accept the offer.

It is noted that selection could occur by inputting an identifier of the desired offer (such as its number) or by tapping or engaging the offer it self (i.e., an offer or portion thereof may be an input). In addition, it is noted that tapping or otherwise engaging an offer may cause a detail view, such as shown in FIG. 4B to be presented. The detail view may only include the table where an offer has been made in some embodiments.

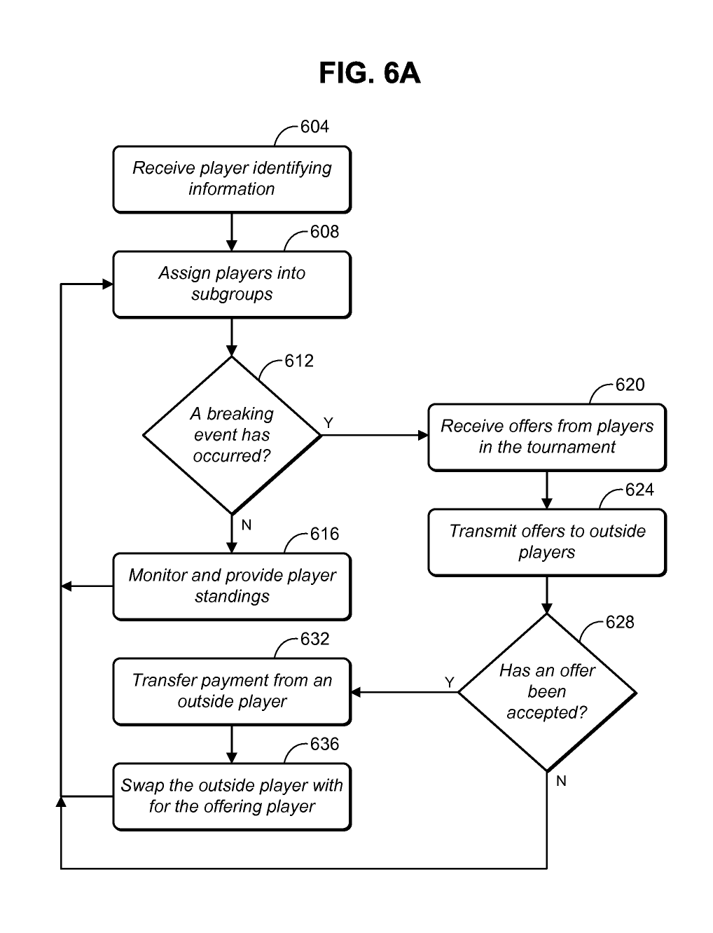

FIG. 5 illustrates an exemplary server of the tournament system. As can be seen, the server 204 may comprise one or more processors 504 and memory devices 508, and utilize one or more storage devices 512. A processor 504 may control the operation of the server 204 to provide the functionality disclosed herein. The processor 504 may be hardwired with instructions for providing this functionality or may execute instructions, such as machine readable code, retrieved from a storage device 512. It is contemplated that the memory devices 508 may be RAM or the like for temporary storage use. More permanent data storage may be provided by the storage devices 512, which may utilize various storage technologies, such as magnetic, optical, or flash based storage. A server 204 may also include one or more displays 520 and user input devices 524 that an administrator or other operator may use to use, control, or otherwise interact with the server.

A server 204 may also include one or more communication devices 516 to permit communication with the tournament system's client devices. As discussed above, a communication device 516 may support various wired or wireless communication links and protocols.

Typically, a communication device 516 will be configured to communicate offers, acceptances of offers, and tournament information between client devices. It is contemplated that multiple communication devices 516 could be used in a server 204, with each providing all or a subset of these communication services. Tournament information 404 may be stored on a storage device 512 that is part of or otherwise accessible to the server 204. Tournament information 404 may also be retrieved therefrom for dissemination to client devices.

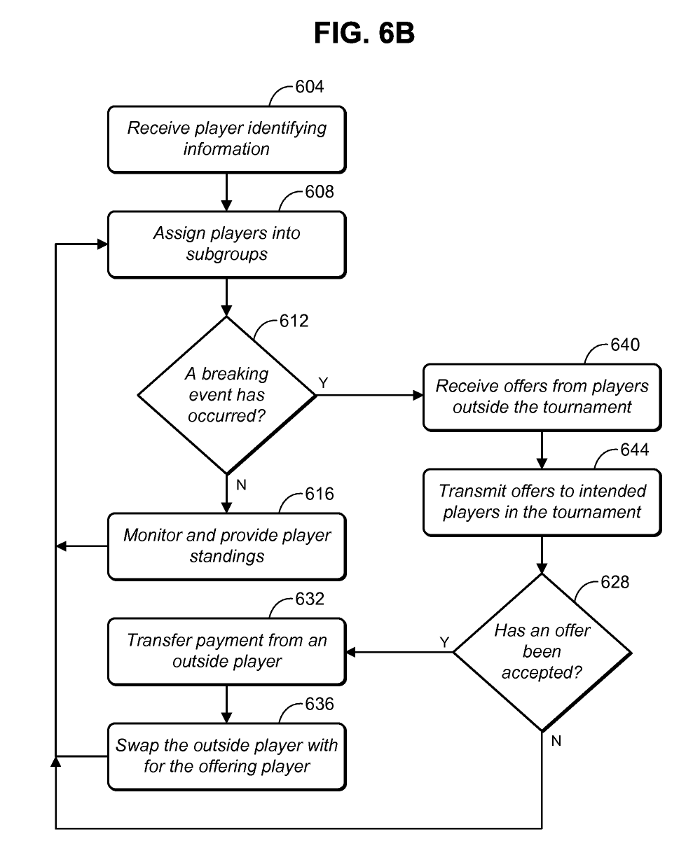

Operation of an exemplary server will now be described with regard to FIG. 6A. At a step 604, the server may receive player identifying information, such as to register players for the tournament, to register outside players so that they may receive offers, or both. The identifying information may be collected at one or more client devices and transmitted to the server therefrom.

Once registration is closed, the server may assign the players in the tournament to random subgroups at a step 608. The players may then play against one another in their subgroups until a breaking event occurs. Detection/determination of a breaking event may occur at a decision step 612. During play, and if a breaking event has not occurred, the server may monitor and update tournament information at a step 616. For example, the server may monitor and update the amount of tournament currency each player has as tournament play continues.

If a breaking event has occurred, the server may proceed to receive offers at a step 620. As can be seen, the tournament system may be configured such that offers may not be made, may not be received, or both until a breaking event has occurred. Once any offers have been received, the server may distribute the offers at a step 624. It is noted that the server may be configured to provide a predefined period of time within which offers may be received. In such embodiments, offers may not longer be made or received outside of such period of time.

Distribution of the offers to outside players may occur in various ways. For example, the server may simply transmit any offer to all outside players. Alternatively, the server may query distribution rules defined by individual outside players and transmit offers accordingly. In this manner, outside players can limit the offers they receive to the offers they desire. The offers can then be transmitted via one or more communication devices of the server.

At a decision step 628, it may be determined if any offers have been accepted. For example, if the server receives an acceptance message from an outside player's client device, the corresponding offer may be considered accepted. Offers and acceptances thereof may include an identifier to specify which offer is being accepted. In general, an offer will be awarded to the first outside player that accepts the offer.

As stated above, an outside player is typically required to make payment before offer acceptance can be completed. The outside player may deposit currency or other funds at an earlier point in time so that these funds can be verified as available, or the outside player may make payment at the time of acceptance. If no funds or insufficient funds are available, the offer may be made available to other outside players. Payment may be made via electronic means, such as electronic funds transfers, credit or debit card payments or the like. In addition or alternatively, payment may be made via physical forms of payment such as by depositing currency or the like in a currency acceptor, such as a bill validator, or coin acceptor.

The outside player's payment or portion thereof may be transferred to the player that made the offer at a step 632. This may also occur electronically or via physical forms of payment. In one or more embodiments, the server may initiate the transfer of funds electronically to move the funds to a bank account belonging to the offering player. Account and authorization information required to effectuate electronic payment and transfer of funds may be collected by the server at registration, when player enter or leave the tournament or both. As stated above, a portion of the offer price payment may be retained by the tournament system operators as fees.

At a step 636, the offering player and the outside player that accepted his or her offer may swap places. Namely, the offering player may be removed from the tournament and the outside player may be entered into the tournament. It is noted that in some embodiments, the offering player could reenter the tournament by accepting an offer. Alternatively, the offering player may be barred from reentry by the server. During the player swap, the outside player would be given the offering player's tournament currency thus taking over the offering player's position in the tournament. Once the player swap is complete, the new player (the former outside player) may be assigned to a subgroup and tournament play may continue at step 608.

The tournament may continue in this manner until enough players are eliminated to determine a winner. For example, if a breaking event results in the elimination of one of two remaining players, the tournament may be ended with the remaining player being deemed the winner of the tournament. If prizes were allocated for multiple winners, the highest ranking players would then be awarded a prize. If there is only a single tournament prize for the overall winner, that player would be awarded the prize.

It is contemplated that outside players may make offers to inside players in one or more embodiments. For example, upon seeing a subgroup and the standings of the players therein, an outside player may wish to replace a player within that subgroup. In such case, the outside player may make an offer (including an offer price) to the inside player holding the outside player's desired position in the subgroup/tournament. If the inside player accepts the offer, the outside player pays the offer price to the inside player, and then replaces the inside player in the tournament such as described above.

FIG. 6B is a flow diagram illustrating operation of a server when accepting offers from outside players. As can be seen, after a breaking event occurs at decision step 612, offers may be received from players outside the tournament at a step 640. The inside player that an outside offer is intended for may then be notified by transmitting the offer to that inside player, such as shown in a step 644. As disclosed above, if the offer is accepted at decision step 628, payment may be transferred at step 632 and the outside player may be entered into the tournament at step 636. It is noted that a server may be configured to accept offers from inside players, outside players, or both in the various embodiments of the tournament.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A poker tournament management system for conducting a poker tournament comprising:
one or more servers configured to record an amount of tournament currency belonging to a plurality of players registered in the poker tournament;
one or more offer devices configured to receive an offer price from a first player and to transmit the offer price to the one or more servers, wherein the first player is one of the plurality of players registered in the poker tournament;
one or more acceptance devices configured to receive an offer identifying the offer price and the amount of tournament currency belonging to the first player and to transmit an acceptance message to the one or more servers when engaged by a second player, wherein the second player is not registered in the poker tournament;
wherein the one or more servers are configured to assign the first player's tournament currency to the second player after the acceptance message is received from the second player.

2. The poker tournament management system of claim 1, wherein the one or more acceptance devices are further configured to receive payment for the offer price.

3. The poker tournament management system of claim 1, wherein the one or more servers are further configured to transfer at least a portion of payment of the offer price from an account of the second player to an account the first player.

4. The poker tournament system of claim 1, wherein the one or more offer devices are further configured to present a poker game for play by the plurality of players registered in the poker tournament.

5. The poker tournament management system of claim 1, wherein the one or more acceptance devices are further configured to present a poker game for play by the plurality of players registered in the poker tournament.

6. The poker tournament management system of claim 1, wherein the one or more servers are further configured to receive the offer price only after a breaking event has occurred.

7. The poker tournament management system of claim 1, wherein the one or more servers are further configured to assign the second player to one of a plurality of subgroupings of the plurality of players registered in the poker tournament.

8. The poker tournament management system of claim 7, wherein the one or more servers are further configured to remove the first player from the plurality of players registered in the poker tournament.

9. A poker tournament management server comprising:
one or more storage devices configured to record an amount of tournament currency belonging to a plurality of players registered to play in a poker tournament;
one or more communication devices configured to:
receive an offer comprising an offer price from a first player; and
receive an acceptance message comprising an identifier identifying the offer from a second player; and
one or more processors configured to assign tournament currency belonging to the first player to the second player, and to remove the first player from the plurality of players registered to play in the poker tournament upon receipt of the acceptance message.

10. The poker tournament management server of claim 9, wherein the one or more processors are further configured to distribute the offer to a plurality of players that are not registered to play in the poker tournament via the one or more communication devices, wherein the second player is one of the plurality of players that are not registered to play in the poker tournament.

11. The poker tournament management server of claim 10, wherein the first player is one of the plurality of players registered to play in the poker tournament and the second player is not one of the plurality of players registered to play in the poker tournament.

12. The poker tournament management server of claim 10, wherein the one or more processors are further configured to distribute the offer only after a breaking event has occurred.

13. The poker tournament management server of claim 9, wherein the one or more communication devices are configured to transmit tournament information comprising player standings of the plurality of players registered to play in a poker tournament.

14. The poker tournament management server of claim 9, wherein the one or more processors are further configured to assign tournament currency belonging to the first player to the second player, and to remove the first player from the plurality of players registered to play in the poker tournament only if the acceptance message is received within a predefined period of time after the offer is received.

15. A method of conducting a poker tournament with a tournament management system comprising:
receiving player identifying information from a first plurality of players to register the first plurality of players to play in the poker tournament;
storing the identifying information on one or more storage devices;
assigning the first plurality of players to a plurality of subgroups;
recording the amount of tournament currency belonging to each of the first plurality of players on the one or more storage devices; and
when a breaking event occurs:
receiving one or more offers from one or more of the first plurality of players, the one or more offers including an offer price;
distributing the one or more offers to a second plurality of players via one or more communication devices, the second plurality of players not being registered to play in the poker tournament;
receiving one or more acceptance messages from the second plurality of players, the one or more acceptance messages identifying one of the one or more offers.

16. The method of claim 15 further comprising assigning the tournament currency of at least one of the first plurality of players to one of the second plurality of players after receipt of the one or more acceptance messages.

17. The method of claim 15 further comprising removing at least one of the first plurality of players from the poker tournament after receipt of the one or more acceptance messages.

18. The method of claim 15 further comprising assigning at least one of the second plurality of players to one of the plurality of subgroups after receipt of the one or more acceptance messages.

19. The method of claim 15 further comprising electronically transferring funds from at least one of the second plurality of players to one of the first plurality of players after receipt of the one or more acceptance messages.

20. The method of claim 15 further comprising, when the breaking event occurs:
receiving one or more outside offers from one or more of the second plurality of players, the one or more outside offers including an offer price, the one or more outside offers intended for a particular one of the first plurality of players;
distributing the one or more outside offers to the particular one of the first plurality of players via one or more communication devices; and
receiving one or more acceptance messages from the particular one of the first plurality of players, the one or more acceptance messages identifying one of the one or more outside offers.
